(19) United States
(12) Patent Application Publication
(10) Pub. No.: US 2024/0226931 A9
(43) Pub. Date: Jul. 11, 2024

(54) PRODUCT DISPENSING SYSTEM COMPRISING A MOTOR DRIVEN AIR PUMP, A DISPENSING DEVICE AND A PRODUCT CONTAINER

(71) Applicant: DISPENSING TECHNOLOGIES B.V., Eindhoven (NL)

(72) Inventors: Paulo Nervo, Hoogeloon (NL); Martinus Wilhelmus Haegens, Nijmegen (NL); Dominicus Jan Van Wijk, Helmond (NL)

(73) Assignee: DISPENSING TECHNOLOGIES B.V., Eindhoven (NL)

(21) Appl. No.: 18/277,617

(22) PCT Filed: Feb. 21, 2022
(86) PCT No.: PCT/NL2022/050089

§ 371 Date: Aug. 17, 2023

(30) Foreign Application Priority Data
Feb. 19, 2021 (NL) 2027605

(51) Int. Cl. B05B 7/24

(52) U.S. Cl. CPC B05B 7/24

(57) ABSTRACT

A dispensing system includes a motor driven air pump having an air inlet and an air outlet, and a dispensing device. The dispensing device is releasably connected to the air pump. The dispensing device includes an air connector connected to the air outlet of the pump, a mixture outlet, a product inlet, and a product uptake system connected to the air connector, the mixture outlet, and the product inlet. The dispensing system includes a product container for a product to be dispensed. The product container is connected to the product inlet. The product container is integrated in the dispensing device. The product uptake system may include an ejector for sucking product from the container and/or a container air inlet for pressurizing the container.

The invention relates to a system for dispensing a product. In particular the invention relates to a dispensing system for dispensing a mixture of a product and pressurized gas, specifically air. Such a product dispensing system may comprise a dispensing device and a pump. The dispensing device may be connectable to a product container.

Various dispensing systems are known. An example of a known product dispensing system is an aerosol, which includes a mixture of a pressurized propellant and product in a pressure-resistant container. Further examples of product dispensing systems are disclosed e.g. in WO 2009/116858 A1 and WO2013/043938 A2

There is a need for an improved product dispensing system.

The invention provides a dispensing system, comprising a motor driven air pump having an air inlet and an air outlet; a dispensing device and a product container for a product to be dispensed. The dispensing device comprises an air connector connected to the air outlet of the pump, a mixture outlet, a product inlet and a product uptake system connected to the air connector, the mixture outlet, and the product inlet. The product container is connected to the product inlet, and is integrated in the dispensing device.

Releasably connecting the dispensing device to the air pump allows the dispensing device to be taken from the air pump, e.g. for cleaning or for refilling a container.

Since the product container is integrated in the dispensing device, the dispensing device may be adapted to the product stored in the integrated container. The customized dispensing device with its integrated container may thus form a cartridge which can be connected to a standard air pump.

The product uptake system may draw product from the product container.

In an embodiment of the dispensing system, the product uptake system may comprises or consist of an ejector arranged downstream of the air connector, when considered in a flow direction of air, wherein the product inlet debouches in the ejector or downstream thereof, the mixture outlet is arranged downstream of the ejector, and wherein the ejector has a smaller cross-sectional area than the mixture outlet. In this embodiment the ejector may draw product from the product container by an underpressure created by the air passing through the ejector at relatively high speed. In this way a very efficient product pump is created. The product drawn from the container and the air may form a mixture which is dispensed through the mixture outlet. The relatively larger cross-sectional area of the mixture outlet aids in creating the desired underpressure, and may additionally or alternatively limit the power required from the motor driven air pump and reduces the risk of clogging. The product may be a liquid or a granulate, e.g. a powder, and the mixture may be dispensed as a mist. The product dispensing system is relatively simple and compact, and its manufacturing cost can be relatively low.

In a further embodiment, the dispensing system may further comprise a plurality of interchangeable dispensing devices. This allows the air pump to be used for dispensing a variety of products, each provided in a separate container.

As an example of the possible applications, a first cartridge may be provided containing a first product, such as a deodorant, and a second cartridge may be provided containing a second product, such as a hair spray. The required parameters of the ejector may differ for the products, for instance due to the desired ratio of air and product at the mixture outlet and/or due to the viscosity of the liquid. Both cartridges may be used with the same motor-driven air pump, in turn, so that only one such air pump is needed. The user can simply use the desired cartridge to dispense the desired product. Since the ejector and the container are part of the same cartridge, the ejector can be ideally designed for the required dispensing behavior. Accordingly, the user is not concerned with combining the right product with the right spray parameters. In fact, the user is unable to choose an unsuitable combination of ejector and container, as the correct combination of ejector and container are integrated with each other in the cartridge.

Other products may also be dispensed, such as other liquids, also those unrelated to cosmetics, such as e.g. olive oil, water, cleaning products or medicine. Moreover, even powders may be dispensed.

An additional or alternative advantage of such an embodiment, is that parts of the dispensing system that are not required to make contact with the product-to-be-dispensed remain separated from it. In particular, contact between the product and the motor-driven air pump can be avoided, so that the pump may be kept free of contamination. Accordingly, the same pump can e.g. be used to dispense different products by replacement of the dispensing device with a similar dispensing device holding a different product, without risking cross-contamination between the dispensing devices for the different products.

Even if the dispensing system is used for one and the same product and/or one and the same dispensing device, it may be advantageous to prevent product contamination of the motor-driven air pump, for instance to avoid buildup of product in moving parts of the motor-driven air pump which would require cleaning, maintenance, or could harm operation of the pump. Thus, the lifetime of the motor-driven air pump can be extended by avoiding product contamination. In particular, the lifetime of the motor-driven air pump may exceed the lifetime during which a single container of a dispensing device can be used up, for instance multiple times, such as a great number of times.

The mixture outlet may debouch into the exterior. A channel, or some other kind of fluid connection, may be provided which extends from the ejector to the mixture outlet. In particular, the channel or connection may prevent fluid from the ejector to flow in any other direction than towards the mixture outlet.

In particular, the container and the air connector may be arranged in parallel, for instance in parallel only (strictly parallel), thereby thus excluding any in-series connection between the air connector and the container. As such, flow of air from the air connector to the container is prevented. Accordingly, contamination of product in the container may be prevented, which may in particular be advantageous in case a container is used multiple times before it is emptied and/or if the product is susceptible to degradation upon exposure to atmospheric substances, such as moisture and/or oxygen.

Alternatively or additionally, the strictly parallel design may prevent a pressure buildup in the container, so that the probability of the container leaking is reduced. As a result, the container may be designed relatively light.

The strictly parallel design may be particularly advantageous in combination with a so-called bag-in-container, as described below. In fact, when using a bag-in-container any contact between ambient air and the product in the container may be avoided, if air is allowed to flow into the interspace between the bag and the container as product is dispensed from the bag.

Alternatively, the container could consist of a bag, or could otherwise be shrinkable or deformable, to allow product to be dispensed from the bag without creating an under-pressure in the container prohibitive of further dispensing.

Alternatively yet, an air inlet or vent opening could be arranged in the container for letting in air as product is dispensed. Although contact of air with the product could in such a case not be excluded, the embodiment may still benefit from the fact that due to the lack of an overpressure, the risk of leaking is reduced. In order to counteract or mitigate the influence of air on the product, the air inlet in the container could be provided with a filter. The air inlet could additionally or alternatively be provided with a stop valve, i.e. a one-way valve, that allows air into the container, but prevents flow of product out of the container through the air inlet in the container. It is also possible to provide the air inlet with an air-permeable but liquid-impermeable element, such as a sieve or membrane.

As yet another alternative, air could be allowed to flow back into the container via the mixture outlet when spraying has stopped. In such a configuration, a temporary underpressure could be generated in the container while spraying, which is resolved by air flowing in the container via e.g. the mixture outlet. Such a configuration has the advantage of not requiring any additional components such as inlets, valves, etc.

As an alternative to the parallel arrangement of the air connector and the container, an in-series configuration is also considered. In such a configuration, the dispensing device may comprise a container air inlet, which connects the air connector to the container. The container may thus be arranged downstream of the air connector, and receive air coming from the air connector when the motor-driven air pump of the dispensing system is operated. The product inlet is connected to the mixture outlet, so that product may flow through the product inlet towards the mixture outlet for dispensing.

The air entering the container from the air connector may increase the pressure in the container, thereby driving out product from the container through the mixture outlet via the product inlet.

In such a configuration the ejector is optional, and may thus be omitted. As such, a strict in-series configuration of the air connector, the container and the mixture outlet is provided in an exemplary embodiment. Such an embodiment has the advantage of being particularly elegant and robust, as there is a very direct connection between air connector, container and mixture outlet. It is noted that the dispensing system in this exemplary embodiment may dispense only product, i.e. not a mixture of product and air. For that reason, the mixture outlet could alternatively be referred to as product outlet.

The exemplary embodiment can be combined with a bag-in-bottle container particularly well, by feeding the air from the air connector between the bottle and the bag. As a result, increasing pressure in the bottle would force out product from the bag. The product can thereby be suitably dispensed, without air contacting the product in the container. It is of course also possible to feed the air into a container or bag in which the product is contained, if the contact between the air and the product is desired.

In order to allow dispensing of a particular mixture of air and product, a further fluid connection may be made between the air connector and the mixture outlet. In such a configuration, the air connector and the container are configured both in series and in parallel. Accordingly, air from the air connector and product, which is forced from the container by air from the air connector, is merged at or upstream of the mixture outlet. In such a configuration, the mixture ratio between product and air can be predetermined relatively accurately depending on the dimensions of the dispensing device. In particular, a flow restriction may be arranged in the product inlet and/or in the further fluid connection, so as to provide suitable ratio flow resistances for dispensing a desired mixture of air and product.

Of course an ejector having a smaller cross-sectional area than the mixture outlet as described-above may be used in conjunction with the in-series connection of the air connector, the container and the mixture outlet, for instance as (part of) the further fluid connection. The ejector may aid in retrieving product from the container. The ejector may additionally or alternatively function as a flow restriction.

It is noted that in order to achieve an enhanced spray performance, the mixture outlet may be provided with a spray nozzle and/or mixing chamber. Use of a spray nozzle and/or mixing chamber is especially advantageous in combination with the strict in-series configuration, as no air flows through the mixture outlet in such a configuration, so that the spray performance will not be enhanced by turbulent flow behavior caused by the presence of air travelling at relatively high speed.

In an embodiment the product inlet may be arranged at an angle to the ejector. In this way a compact dispensing device is obtained.

In a further embodiment the product inlet may be substantially perpendicular to the ejector. This allows the product container to be arranged close to the air conduit and the length of the product inlet to be minimized.

In an embodiment of the dispensing system the ejector may be convergent when considered in the air flow direction. In this way the air flow is accelerated in the ejector, thus leading to a further pressure reduction of the air flowing out of the ejector, which will increase a suction force acting on the product.

In an embodiment, the dispensing system may further comprise a flow restriction arranged in the product inlet to ensure precise dosing of the product to be dispensed.

In yet another embodiment, the dispensing system may further comprise a one-way valve arranged in the product inlet. This allows the dispensing system to be used in any random orientation without the risk of product leaking from the container.

In a further embodiment the dispensing system may comprise a plurality of product inlets. In this way different products may be dispensed as a mixture, e.g. to dispense a two-component liquid.

In that case the dispensing system may further comprise a mixture conduit between the ejector and the mixture outlet, wherein the product inlets may debouch in the mixture outlet at spaced apart locations. This allows the individual products to be drawn into the air stream in a controlled manner to achieve a predetermined mixing ratio.

In a further embodiment, the dispensing system may comprise a flow restriction arranged in the mixture conduit between adjacent product inlets, which will accelerate the mixture towards the mixture outlet.

In an embodiment, the product container may comprise a bag-in-container. Such a bag-in-container allows a product to be held and dispensed without coming into contact with ambient air, thus preventing contamination or deterioration of the product. Moreover, only a relatively small underpressure is required for drawing product from a bag-in-container.

A compact, simple, clean and low-noise dispensing system may be obtained if the air pump comprises an electric motor and an electric power supply connected to the electric motor.

In an embodiment of the dispensing system, the air pump may be configured to draw in ambient air through the air inlet, to pressurize the ambient air to an overpressure of between 0.1 and 2.0 bar, preferably 0.25 and 1.0 bar, more preferably approximately 0.5 bar, and to supply the pressurized air through the air outlet. At these values of the air pressure a strong suction force may be generated at the ejector, while still limiting both the rate at which the product is dispensed and the power requirements on the air pump.

In a further embodiment, the air pump may have a variable output and may comprise a controller for controlling the output. In this way a user may adjust the output of the dispensing system.

To this end the motor of the air pump may have a variable speed and/or variable power, and the controller may be configured for controlling the speed and/or power of the motor.

In order to allow the dispensing system to be controlled on the basis of remote control signals, the air pump may comprise a transceiver connected to the controller.

In a further embodiment, the dispensing system may comprise an identifier connected with the dispensing device or the product container, and the transceiver may be configured for communication with the identifier. In this way the operation of the air pump may be adjusted on the basis of the identity of the dispensing device or the product container. For instance, when a container is identified as containing a more highly viscous liquid or powder, the output of the air pump may be increased. The same may apply if the dispensing device is identified as having e.g. a relatively narrow nozzle.

In an embodiment of the dispensing system, the transceiver may be configured for communication with an external device. This allows the system to be controlled e.g. through an app that is installed on a smartphone or tablet.

In a further embodiment of the dispensing system, the air pump, dispensing device and/or product container may be configured for the dispensing system to be handheld. In this way a user may carry the dispensing system around so that it is always available for use.

The invention also relates to a motor driven air pump for use in the dispensing system as described above, and to a dispensing device for use in such a dispensing system. And finally, the invention relates to a combination of such a dispensing device and a product container connected to the product inlet.

The invention will now be elucidated by way of a number of exemplary embodiments, with reference being made to the annexed drawings, in which:

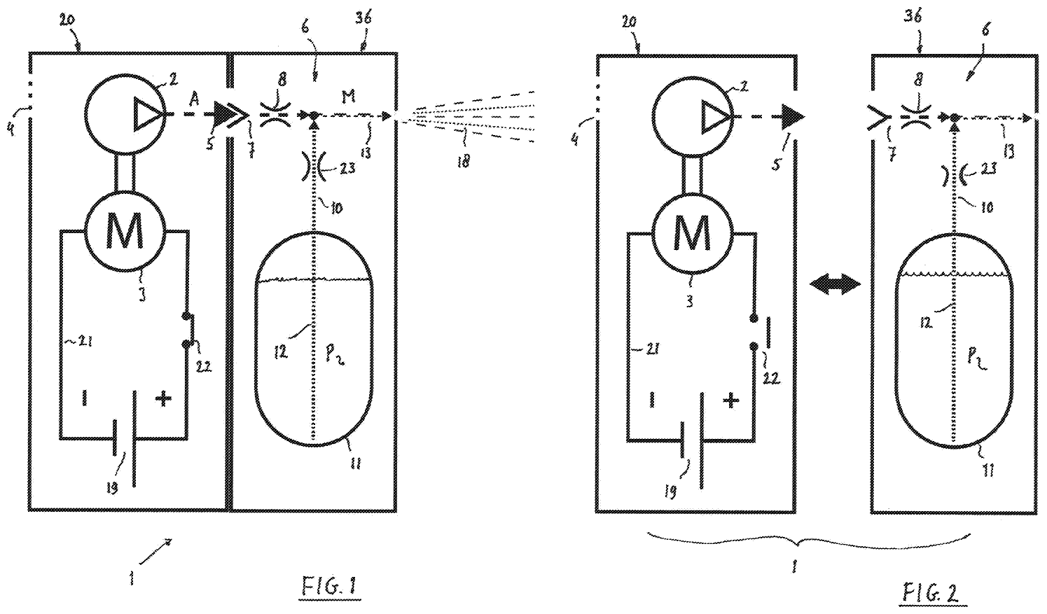

FIG. 1 is a schematic representation of a dispensing system in accordance with a first embodiment, having an air pump and a dispensing device with integrated product container releasably connected thereto;

FIG. 2 shows the air pump and dispensing device of FIG. 1 after they have been released from each other;

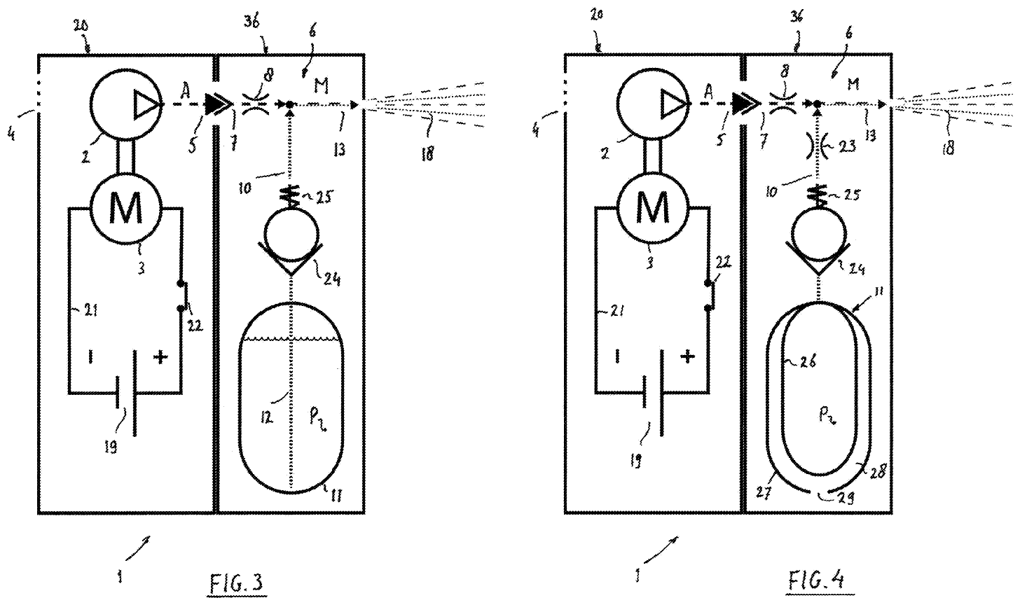

FIG. 3 is a schematic representation of a second embodiment of the dispensing system having a one-way valve in its product inlet;

FIG. 4 shows a third embodiment of the dispensing system in which the product container is a bag-in-bottle;

FIG. 5 is a schematic representation of a fourth embodiment of the dispensing system, in which the dispensing device is integrally formed with the air pump, while the product container is releasably connected to the dispensing device;

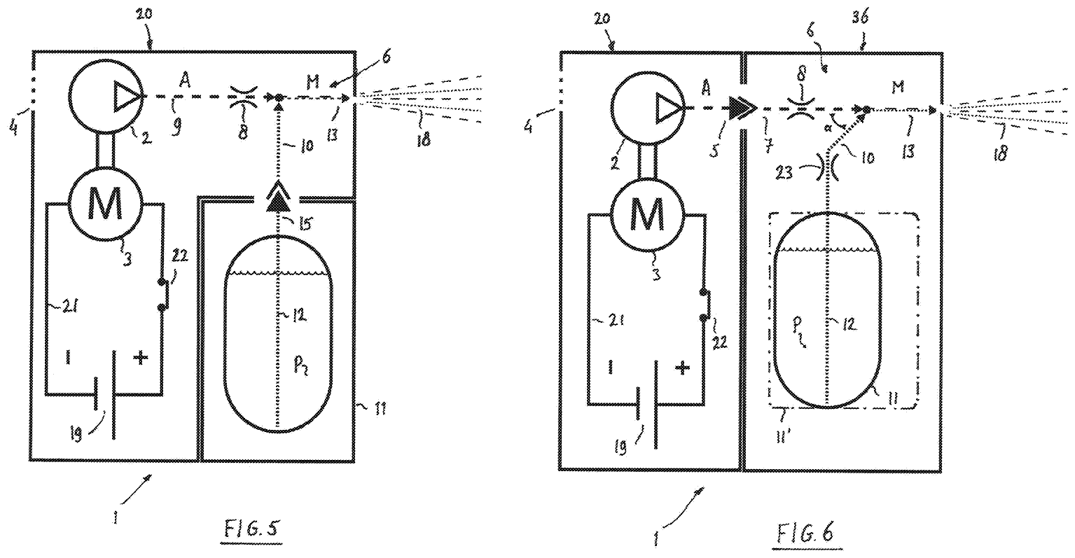

FIG. 6 shows a fifth embodiment of the dispensing system in which the product inlet is oriented at an acute angle to the ejector;

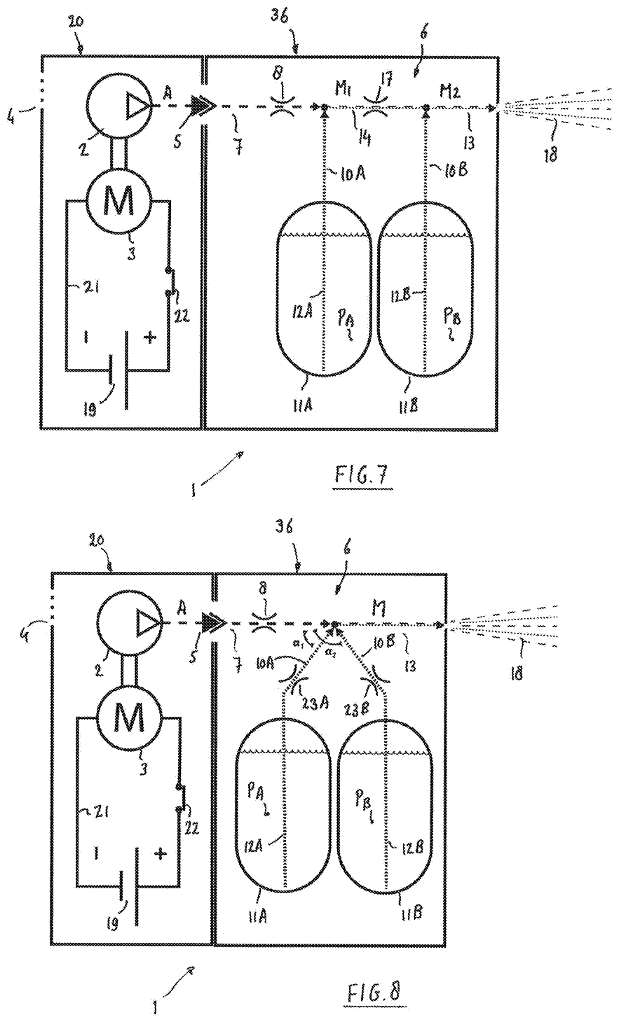

FIG. 7 is a schematic representation of a sixth embodiment of the dispensing system, in which two product containers are in product communication with the ejector and mixture conduit, respectively, in a series connection;

FIG. 8 shows a seventh embodiment of the dispensing system, in which two product containers are collectively in product communication with the ejector;

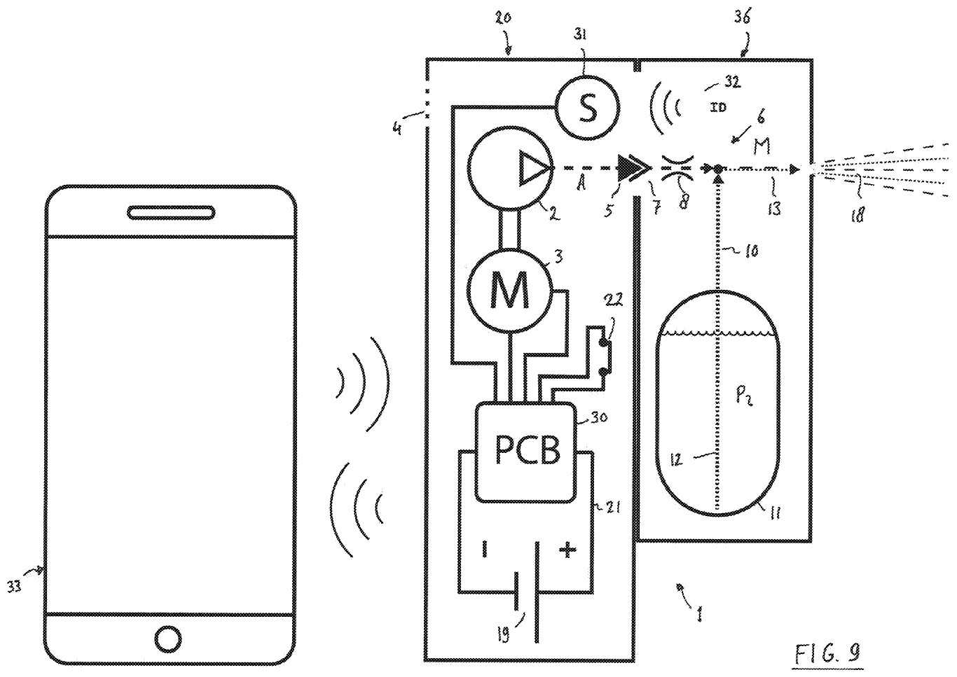

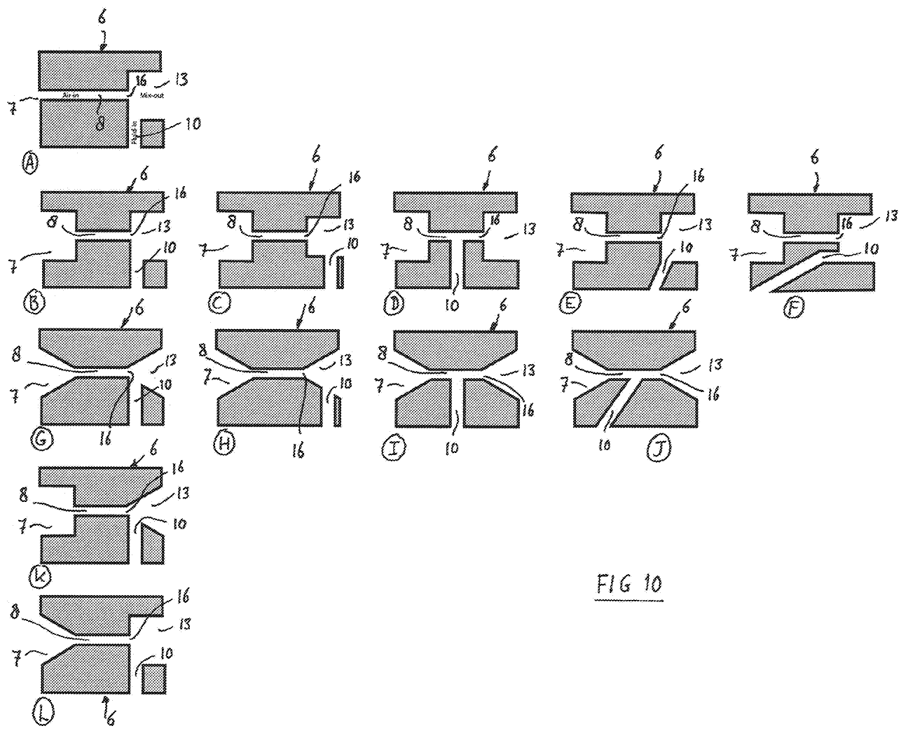

FIG. 9 is a schematic representation of an eight embodiment of the dispensing system, in which the air pump includes a controller and a transceiver, in combination with a mobile device which communicates with the dispensing system;

FIGS. 10A-10L are schematic representations of a variety of configurations for the dispensing device, which may be used in various embodiments of the dispensing system;

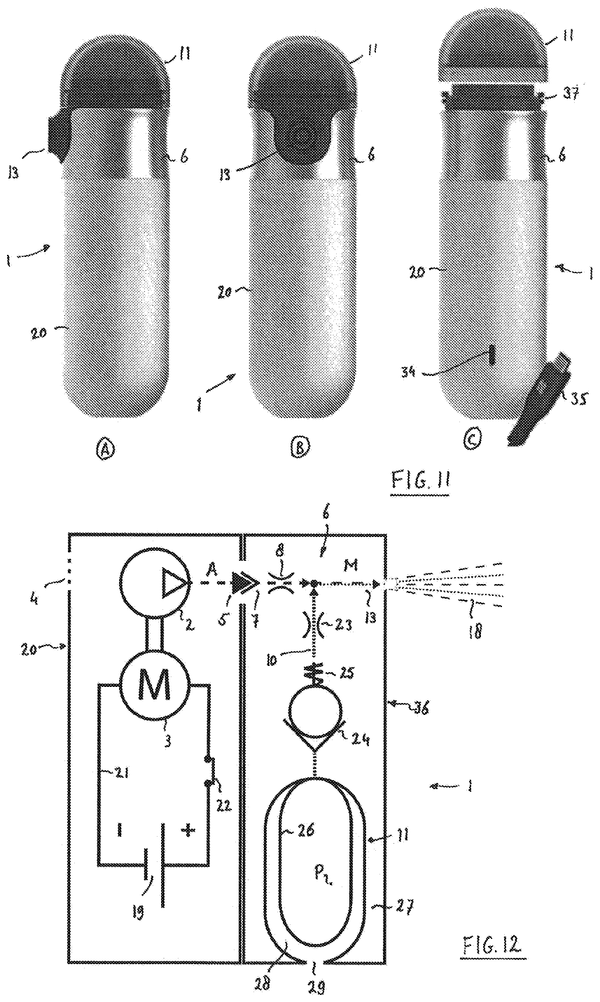

FIGS. 11A and 11B show a side view and front view, respectively, of a ninth embodiment of the dispensing system;

FIG. 11C shows a rear view of the dispensing system of FIGS. 11A and 11B, in which the product container is disconnected from the dispensing device;

FIG. 12 shows a variant of the embodiment of FIG. 4 in which the cartridge forms part of the bag-in-bottle type container;

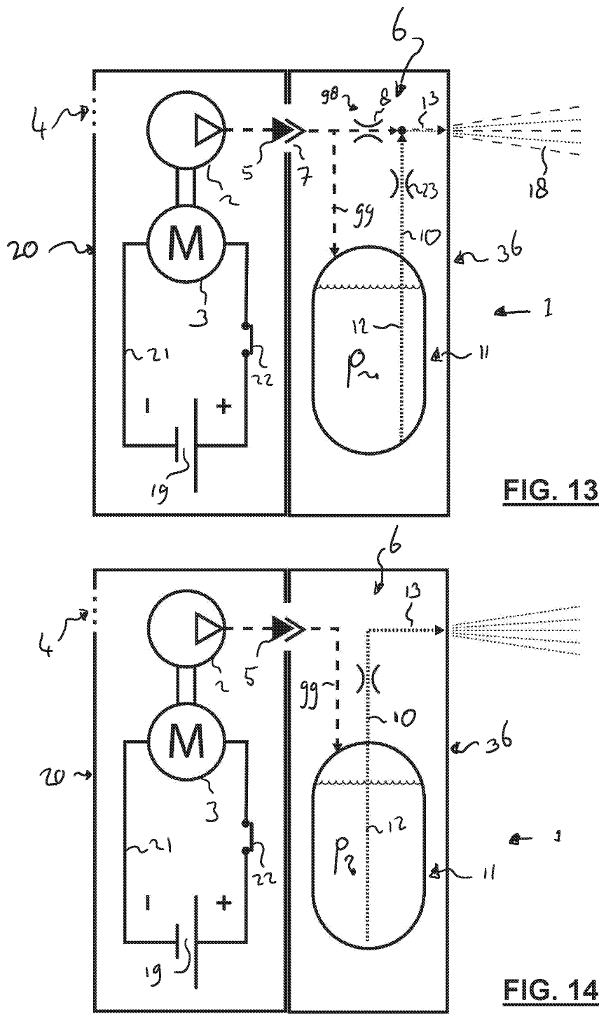

FIG. 13 is a schematic representation of a tenth embodiment of the dispensing system, in which a container is connected in series and in parallel to an air connector; and

FIG. 14 is a schematic representation of an eleventh embodiment of the dispensing system, in which a container is connected in series to an air connector.

A dispensing system 1 comprises a motor driven air pump 20 and a dispensing device 6 (FIG. 1). The air pump 20 has an air inlet 4 and an air outlet 5. In the illustrated embodiment the air pump 20 comprises a airflow generator 2, e.g. a fan, a piston pump or a wobble pump, which is connected to and driven by a motor 3. In this embodiment the dispensing device 6 is shown to be releasably connected to the air pump 20. This allows the dispensing device 6 to be replaced by another dispensing device having a similar connection, or to be refilled and reinstalled.

The dispensing device 6 comprises an air connector 7 which is connected to the air outlet 5 when the dispensing device is connected to the air pump 20, and an ejector 8 which is in product communication with the air connector 7. The dispensing device 6 further comprises a product inlet 10 (FIG. 10) which can be connected to a container 11 which is at least partially filled with a product P. In this embodiment the product inlet 10 debouches immediately downstream of the ejector 8. There is further shown to be a flow restriction 23 arranged in the product inlet 10. A dip tube 12 extends from the product inlet 10 into the product container 11. And finally, the dispensing device 6 comprises a mixture outlet 13 which is arranged downstream of the ejector 8.

In the illustrated embodiment the product container 11 is integrated in the dispensing device 6, so that these two parts together form a cartridge 36 that may be replaceable or refillable.

However, in another embodiment the product container 11 may be a separate part having a product outlet 15 that is connectable to the product inlet 10 of the dispensing device 6 (FIG. 5). In that embodiment the dispensing device 6 is shown to be integrated with the air pump 20, so that the entire dispensing system 1 still has no more than two constituent parts. This embodiment lacks the air outlet and air connector of the previous embodiments, and instead has an air conduit 9 running from the airflow generator 2 to the ejector 8.

It should be noted that it is also conceivable for the dispensing device 6 to be separate both from the air pump 20 and from the product container 11, as shown in FIG. 10. In that way the dispensing system 1 comprises three constituent elements.

In the illustrated embodiment the ejector 8—i.e. a central axis of the ejector—and the product inlet 10—i.e. a central axis of the inlet—are arranged at an angle α to each other. This angle α may be a right angle, as shown in FIG. 1, so that the product inlet 10 and the ejector 8 are substantially perpendicular to each other, but it is also conceivable that an acute angle α is selected, as shown in FIG. 6. Such an acute angle α may be beneficial to improve mixing of the product P with the air A. An acute angle α may also be selected for reasons of providing a compact system, e.g. if the product outlet 15 is arranged eccentrically on the product container 11′—as shown in dash-dotted lines.

As shown in FIGS. 10A-L, the air connector 7, the ejector 8, the product inlet 10 and the mixture outlet 13 may have various configurations, depending on the characteristics of the product P to be dispensed and/or the characteristics of the air pump 20. In all configurations the cross-sectional area of the ejector 8 at the location 16 where it debouches in the mixture outlet 13 is smaller than the cross-sectional area of the mixture outlet 13.

This cross-sectional area determines the flow velocity vₐ of the air A in the ejector 8, and in accordance with Bernouilli's principle this in turn determines the air pressure p a in the ejector 8. Since the cross-sectional area of the mixture outlet 13 is greater than that of the ejector 8, the airflow exiting the ejector 8 will expand and decelerate, resulting in a pressure rise towards ambient pressure p_{amb}. The air pressure p a in the ejector 8 or at its exit 16, which is lower than ambient pressure p_{amb}, exerts a suction force on the product P in the container 11, which is drawn through the product inlet 10 into the ejector 8. The (optional) flow restriction 23 in the product inlet 10 serves to regulate the product flow from the container 11 to the ejector 8, where the product P is mixed with the air A. The resulting mixture M is expelled through the mixture outlet 13, from where it is dispensed as a fine mist 18.

FIG. 10A shows the most basic configuration of the dispensing device 6, where the ejector 8 is a straight channel that is relatively narrow when compared to the mixture outlet 13, which is represented as a relatively wide, straight-walled recess. The product inlet 10 is shown to debouch in the mixture outlet 13, immediately downstream of the ejector 8.

FIGS. 10B-10F show configurations of the dispensing device 6 in which the mixture outlet 13 is again represented as a relatively wide, straight-walled recess, while the air connector 7 is shown in a similar way. The air connector 7 and the mixture outlet 13 are shown to be connected by the ejector 8, and the product inlet 10 is shown at various locations and at different orientations. In FIG. 10B the product inlet 10 is the same as in FIG. 10A, while in FIG. 10C it is shown to be arranged further downstream of the ejector 8, which may lead to a weaker suction force being exerted on the product to be dispensed. In FIG. 10D, on the other hand, the product inlet 10 is shown to debouch in the ejector 8, which may lead to a stronger suction on the product. In FIG. 10E the product inlet 10 is arranged immediately downstream of the ejector 8, like in FIGS. 10A and 10B, but at an acute angle, whereas in FIG. 10F the product inlet 10 debouches in the mixture outlet 13 such that the flow of product P is parallel to the airflow A.

FIGS. 10G-10I show similar configurations as FIGS. 10B-10D, in which the air connector 7 is shown to converge, while the mixture outlet 13 is shown to diverge. In this way pressure losses in the flow are minimized FIG. 10J is similar to FIG. 10I, but shows the product inlet 10 at an acute angle, rather than a straight angle to the ejector 8.

And finally, FIG. 10K combines the straight-walled air connector 7 of FIG. 10B with the diverging mixture outlet 13 of FIG. 10G, while FIG. 10L combines the converging air connector 7 of FIG. 10G with the straight-walled mixture outlet 13 of FIG. 10B.

Although the schematic representations of FIGS. 10A-10L only show straight walls and sharp edges, it will be apparent that in practice the walls may be curved and the edges rounded, in order to minimize aerodynamic losses.

In all embodiment illustrated thus far the motor 3 is an electric motor and the air pump 20 further comprises an electric power supply 19, e.g. a battery, which is connected to the motor 3 through a circuit 21 including a switch 22. When the switch 22 is closed the electric motor 3 is powered and the airflow generator 2 is operated to draw in ambient air through the air inlet 4, pressurize the ambient air drawn in and supply the pressurized air through the air outlet 5. The switch 22 can be automatically closed when the dispensing device 6 is connected to the air pump 20, or the switch 22 may be operable by a user of the dispensing system 1. The switch 22 may be open and the air pump 20 switched off whenever it is disconnected from the dispensing device 6 (FIG. 2).

In this embodiment the airflow generator 2 and the electric motor 3 are dimensioned such, and the air inlet 4 and air outlet 5 are configured such, that the ambient air can be pressurized to an overpressure of between 0.1 and 2.0 bar, preferably 0.25 and 1.0 bar, more preferably approximately 0.5 bar. This range of pressures ensures that a wide range of products having widely varying viscosities may be dispensed as a fine mist 18, i.e. atomized. The products may range from relatively thick, i.e. highly viscous oils to relatively thin watery liquids, and may even be fine granulates or powders.

In a further embodiment the dispensing device 6 comprises a one-way valve 24 arranged in the product inlet 10—which in this case does not include a flow restriction (FIG. 3). This valve 24, which is shown here to be biased by to a closed position by a spring 25, prevents any product P leaking from the container 11. This in turn allows the dispensing system 1, which is shown here in an upright position, to be used in any random orientation, thus greatly increasing usability. Moreover, the one-way valve 24 allows the dispensing system 1 to be transported e.g. in a user's bag or pocket without the risk of spilling product. Instead of by a separate spring or other biasing element, the one-way valve 24 may also be biased to its closed position by inherent flexibility of a material of which it is constructed, e.g. silicone, rubber or an elastomer.

The dispensing system 1 can be used with a variety of product containers. In one embodiment, which also includes the one-way valve 24, the product container 11 may be a bag-in-container (FIG. 4). In this embodiment the product container comprises a relatively flexible inner container or “bag” 26 which is arranged in a relatively stiff outer container or “bottle” 27. An interspace 28 between the inner and outer containers 26, 27 is in product communication with the atmosphere through an opening 29. Such a bag-in-container prevents the product to be dispensed from being exposed to the atmosphere. Moreover, the ejector 8 only has to generate a relatively limited underpressure to draw product from the bag-in-container. In this embodiment there is no need for a dip tube, but the use of a bag-in-container does require a one-way valve 24 to be arranged in the product inlet 10. The product inlet 10 is further shown to include a flow restriction 23.

Instead of arranging a separate bag-in-bottle type container 11 in the cartridge 36, it is also conceivable that a part of the cartridge 36 itself may form the relatively stiff outer container or “bottle” 27 of the bag-in-bottle (FIG. 12). In this case the opening 29 will be formed directly in an outer wall, here the bottom wall of the cartridge 36.

Although the embodiments shown thus far included only a single product container 11, it is also conceivable for the dispensing system 1 to comprise a plurality of product inlets. In the embodiment of FIG. 7 the dispensing device 6 includes two product inlets 10A, 10B. The product inlets 10A, 10B are connected to two dip tubes 12A, 12B protruding into respective product containers 11A, 11B which may contain two products PA and PB. These products PA, PB may for instance be two components of a composition which must be stored separately before use.

The first product inlet 10A guides the first product PA to a location immediately downstream of the ejector 8, where it is mixed with the air A to form a first mixture M1. This first mixture M1 is guided through a mixture conduit 14, which includes a flow restriction 17. The second product inlet 10B guides the second product PB to the part of the mixture conduit downstream of the flow restriction 17, where it is mixed with the first mixture M1 to form a second mixture M2. This second mixture M2 is then dispensed as a fine mist 18 from the mixture outlet 13. In this embodiment the flow restriction 17 has a greater cross-sectional area than the ejector 8, while the mixture outlet 13 has a greater cross-sectional area than the flow restriction 17, so that the flow velocity decreases and the pressure increases in the direction of flow. A suitable selection of the diameter of the flow restriction 17 allows a mixing ratio of the two products PA:PB to be set at a desired value.

In a more compact embodiment the two product inlets 10A, 10B may converge and meet near the ejector 8 (FIG. 8). In that case the first product inlet 10A runs at an acute angle α1 with respect to the ejector 8, whereas the angle α2 between the ejector 8 and the second product inlet 10B is obtuse. Where the two product inlets 10A and 10B meet the ejector 8, the two products PA and PB mix with the air A to form the final mixture M, which is again expelled through the mixture outlet 13. In this embodiment, like in the embodiment of FIG. 7, the flow restrictions 23A, 23B in the first and second product inlets 10A, 10B serve to regulate the flow rate of each of the two products PA, PB and thus also the mixing ratio of these products.

In the embodiments shown thus far the air pump 20 has two states, on or off. In a further embodiment of the dispensing system 1 as shown in FIG. 9 the air pump 20 has a variable output and comprises a controller 30 for controlling the output. The output may be varied in different ways, e.g. by means of a controllable element like a valve or a throttle between the air inlet 4 and the air outlet 5 or by a variable configuration of the airflow generator 2. In the illustrated embodiment the motor 3 of the air pump 20 has a variable speed and/or variable power, and the controller 30 is configured for controlling the speed and/or power of the motor 3.

The controller 30 may be operated manually, e.g. by means of a slide or rotary knob, but in the illustrated embodiment the air pump 20 comprises a transceiver 31 connected to the controller 30, thus allowing the air pump 20 to be controlled remotely. In this embodiment there is an identifier 32 which is connected with the dispensing device 6 that includes the product container 11. This identifier 32 may include information about the product P contained in the product container 11, e.g. its viscosity. Additionally or alternatively, the identifier 32 may include information about the configuration of the dispensing device, e.g. about the ejector 8 and the various flow restrictions 17, 23. All this information may be relevant for setting an appropriate motor speed and/or motor power. The transceiver 31 is configured for communication with the identifier 32, so that the information from the identifier 32 may be transferred to the controller 30. The controller 30 may then determine the optimum speed and/or power settings and control the motor 3 accordingly.

It is also conceivable that the identifier 32 merely contains an ID code, and that the controller 30 includes a look-up table containing the necessary information about characteristics of the product P and/or the dispensing device 6. The identifier 32 may e.g. be a RFID tag and the transceiver 31 may comprise an RFID reader.

Alternatively or additionally, the transceiver 31 may be configured for communication with an external device 33, e.g. a smartphone or a tablet. A program or app for controlling the dispensing system 1 may be installed on the external device, and a user may communicate with the program or app through a GUI. The program or app may cause the external device 33 to send instructions to the transceiver 31 and hence to the controller 30, or to receive information from the controller 30 through the transceiver 31. The user may for instance request information about the status of the product container 11, e.g. the nature of its contents and/or the amount of product left, or about the air pump 20 or dispensing device 6, e.g. statistics of use, maintenance message, etc. The user may also enter information, like e.g. personal settings, which may be stored in the controller 30 for future use.

Communication between the transceiver 31 of the dispensing system 1 and the external device 33 may be implemented by any known protocol, like e.g. Bluetooth, Wifi or GSM.

A practical embodiment of the dispensing system 1 is shown in FIG. 11. In this embodiment the air pump 20 and the product container 11 are arranged at opposite sides of the dispensing device 6. The air pump 20 is shown to have a slender cylindrical housing, while the dispensing device 6 has a relatively smaller cylindrical housing. The mixture outlet 13 comprises a nozzle which protrudes from the cylindrical housing of the dispensing device 6. The product container 11 is semi-spherical, and is arranged upside down on the dispensing device 6, i.e. with its product outlet (not shown) oriented downward. The product container 11 is shown to be releasably connected to the dispensing device 6 by means of a connector 37, e.g. a bayonet or screw thread. In FIG. 11C a socket 34 is shown which receives a charging cable 35 for recharging the power supply 19. The dispensing system 1 is shown to be designed and dimensioned to be handheld, and may have similar dimensions as e.g. a conventional deodorant dispenser.

Another embodiment of the dispensing system 1 is shown in FIG. 13. The dispensing system 1 is similar to that of FIGS. 1 and 2. As such, only differences will be described herein. It is noted that variations to the dispensing system 1 of FIG. 13 are possible, for instance those explained with reference to above-described embodiments. The dispensing device 6 of FIG. 13 differs from that of FIG. 1 in that a product air inlet 99 is provided. The product air inlet 99 connects the air connector 7 to the container 11, so that air flows in from the air connector 7 to the container 11 when the motor driven air pump 20 is operated. The incoming air in the container 11 pressurizes the product P in the container 11, thereby forcing it out through product inlet 10, and ultimately out the dispensing device 6 via mixture outlet 13. The product inlet 10 in FIG. 13 still debouches at or near the ejector 8, which is a flow restriction, so that air and product P mix and are dispensed together as a fine mist 18. As air flows from the air connector 7 to both the container 11 and through the ejector 8, the container 11 is connected to the air connector 7 in parallel as well as in series.

Yet another embodiment of the dispensing system 1 is shown in FIG. 14. The dispensing system 1 is similar to that of FIG. 13. As such, only differences will be described herein. The dispensing device 6 differs from that of FIG. 1 in that no ejector 8 is provided. As such, the parallel connection of FIG. 13 is removed, so that the container 11 is connected in series only to the air connector 7. The dispensing device 6 works following an increased pressure in the container 11 due to the air supplied via the air connector 7, which forces product P out of the container 11. Product P leaves the container 11 via product inlet 11, and flows out of the mixture outlet 13. In this embodiment, the product P is not necessarily mixed with air, so that the mixture outlet 13 may also be referred to as product outlet 13.

In this way a wide variety of products may be atomized using a single handheld air pump, which may easily be carried around. The dispensing system 1 may be used for personal care, e.g. to dispense a deodorant, an eau de toilette, a suntan lotion, a dry shampoo, etc. Alternatively, the dispensing system 1 may be used in household settings, e.g. to dispense oils, condiments or detergents. It is also conceivable that the system is used to dispense a water mist for cooling purposes. The dispensing system can be a low cost and lightweight appliance, which can have various configurations and designs, dependent on its use.

Although the invention has been illustrated by way of various exemplary embodiments, it will be clear that the invention is not limited to these embodiments, but can instead be varied within the scope of the appended claims.

1-24. (canceled)

25. A dispensing system, comprising:
a motor driven air pump having an air inlet and an air outlet;
a dispensing device releasably connected to the air pump, the dispensing device comprising:
an air connector connected to the air outlet of the pump;
a mixture outlet;
a product inlet; and
a product uptake system connected to the air connector, the mixture outlet, and the product inlet; and
a product container for a product to be dispensed, the product container connected to the product inlet,
wherein the product container is integrated in the dispensing device.

26. Dispensing system according to claim 25, wherein the product uptake system comprises or consist of:
an ejector arranged downstream of the air connector, when considered in a flow direction of air, wherein:
the product inlet debouches in the ejector or downstream thereof;
the mixture outlet is arranged downstream of the ejector; and
wherein the ejector has a smaller cross-sectional area than the mixture outlet.

27. The dispensing system of claim 25, further comprising a plurality of interchangeable dispensing devices.

28. The dispensing system of claim 26, wherein the product inlet is arranged at an angle to the ejector.

29. The dispensing system of claim 26, wherein the product inlet is substantially perpendicular to the ejector.

30. The dispensing system of claim 26, wherein the ejector is convergent when considered in the air flow direction.

31. The dispensing system of claim 25, further comprising a flow restriction arranged in the product inlet.

32. The dispensing system of claim 25, further comprising a one-way valve arranged in the product inlet.

33. The dispensing system of claim 25, further comprising a plurality of product inlets.

34. The dispensing system of claim 33, further comprising a mixture conduit between the ejector and the mixture outlet, wherein the product inlets debouch in the mixture outlet at spaced apart locations.

35. The dispensing system of claim 34, further comprising a flow restriction arranged in the mixture conduit between adjacent product inlets.

36. The dispensing system of claim 25, wherein the product container comprises a bag-in-container.

37. The dispensing system of claim 25, wherein the air pump comprises an electric motor and an electric power supply connected to the electric motor.

38. The dispensing system of claim 25, wherein the air pump is configured to draw in ambient air through the air inlet, to pressurize the ambient air to an overpressure of between 0.1 and 2.0 bar, and to supply the pressurized air through the air outlet.

39. The dispensing system of claim 25, wherein the air pump has a variable output and comprises a controller for controlling the output.

40. The dispensing system of claim 39, wherein the motor of the air pump has a variable speed and/or variable power, and wherein the controller is configured for controlling the speed and/or power of the motor.

41. The dispensing system of claim 39, wherein the air pump comprises a transceiver connected to the controller.

42. The dispensing system of claim 41, further comprising an identifier connected with the dispensing device or the product container, wherein the transceiver is configured for communication with the identifier, and optionally wherein the transceiver is configured for communication with an external device.

43. The dispensing system of claim 25, wherein the air pump, dispensing device and/or product container are configured for the dispensing system to be handheld.

44. The dispensing system of claim 25, wherein the product uptake system comprises or consists of:
a container inlet which connects the air connector to the container, wherein:
the product inlet is connected to the mixture outlet, and optionally a further fluid connection between the air connector and the mixture outlet.
